(19) United States
(12) Patent Application Publication
(10) Pub. No.: US 2010/0215869 A1
(43) Pub. Date: Aug. 26, 2010

(54) METHOD FOR GENERATING A CERAMIC LAYER ON A COMPONENT

(75) Inventors: Jens Dahl Jensen, Berlin (DE); Ursus Krüger, Berlin (DE); Daniel Körtvelyessy, Berlin (DE); Ralph Reiche, Berlin (DE); Gabriele Winkler, Berlin (DE)

Correspondence Address: King & Spalding LLP, 401 Congress Avenue, Suite 3200, Austin, TX, 78701, US

(73) Assignee: SIEMENS AKTIENGESELLSCHAFT, MUNCHEN (DE)

(21) Appl. No.: 12/666,823

(22) PCT Filed: Jun. 13, 2008
(86) PCT No.: PCT/EP08/57468

§ 371 Date: Dec. 28, 2009

(30) Foreign Application Priority Data
Jun. 27, 2007 (DE) 10-2007-030-585.2

(51) Int. Cl. B05D 3/06; B05C 9/12

(52) U.S. Cl. 427/557; 118/620; 977/773

(57) ABSTRACT

In a process for producing a ceramic layer (14) on a component (15) in a microwave oven (11), it is provided that a microwave generator (12) generates microwaves (17) of a defined frequency which selectively heats only constituents of the coating material (14) applied for coating the component (15). It is thereby advantageously possible to produce a ceramic layer from the precursors present in the coating material with low energy consumption and with low thermal loading of the component (15). The frequency of the microwave excitation can be set, for example, to the solvent (acetic acid, propionic acid) present in the coating material or to the heating of particles of intermetallic compounds or ceramics present in the coating material for this purpose.

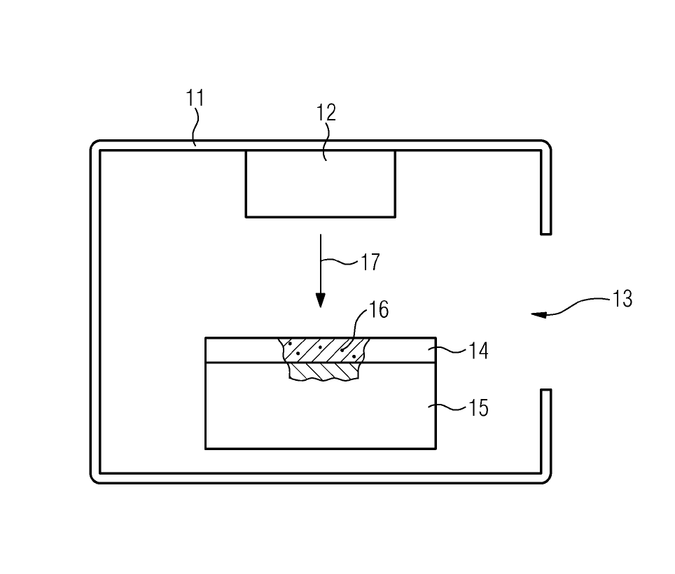

### CROSS-REFERENCE TO RELATED APPLICATIONS

This application is a U.S. National Stage Application of International Application No. PCT/EP2008/057468 filed Jun. 13, 2008, which designates the United States of America, and claims priority to German Application No. 10 2007 030 585.2 filed Jun. 27, 2007, the contents of which are hereby incorporated by reference in their entirety.

### TECHNICAL FIELD

The invention relates to a process for producing a ceramic layer on a component, in which a coating material consisting of a solvent and the dissolved precursors of a ceramic is applied to the component. In a further step, the component provided with the coating material is subjected to heat treatment in which the solvent evaporates and the ceramic precursors are converted into the ceramic layer, the energy source used for the heat treatment being a microwave generator.

### BACKGROUND

The process of applying ceramic precursors to metallic components in order to form ceramic layers on said components is known per se and is described, for example, in US 2002/0086111 A1, WO 2004/013378 A1, US 2002/0041928 A1, WO 03/021004 A1 and WO 2004/104261 A1. The processes described in these documents relate to the production of ceramic coatings on components in general, wherein the layer is produced using ceramic precursors of the ceramics to be produced which, after they have been applied, are converted to the ceramic to be formed by heat treatment.

The ceramic precursors contain the materials of which the ceramic material of the layer to be formed is composed, and furthermore have constituents which, during the chemical conversion which proceeds when the coating material is subjected to heat treatment, lead to crosslinking of the ceramic material. Examples of ceramic precursors can be gathered from the cited prior art documents and should be selected depending on the intended application.

By way of example, it is possible that the ceramic to be formed consists of an oxide and/or a nitride and/or an oxynitride. The formation of oxides, nitrides or oxynitrides advantageously makes it possible to produce particularly stable layers. The precursors of such ceramics have to provide the elements N and/or O in order to form the oxidic, nitridic or oxynitridic ceramic.

Furthermore, it is known from US 2006/0039951 A1 to produce layers of a coating material which contains dissolved precursors of a ceramic on a component. The layer is formed by placing the component with the coating material in a microwave oven which, for example, is also used to heat meals in homes. The component with the coating material is heated in the microwave oven such that the ceramic precursors are converted into the ceramic layer.

### SUMMARY

According to various embodiments, a process for producing a ceramic layer can be specified, in which it is necessary to use a comparatively small amount of energy and in which the component is subjected to comparatively low thermal loading during the coating.

According to an embodiment, a process for producing a ceramic layer on a component, may comprise the steps of—applying a coating material comprising a solvent and dissolved precursors of a ceramic to the component, and—subjecting the component provided with the coating material to heat treatment in which the solvent evaporates and the ceramic precursors are converted into the ceramic layer, the energy source used for the heat treatment being a microwave generator, wherein particles, in particular nanoparticles, are introduced into the coating material, wherein the particles are selected in view of groups of atoms which are present in the coating material, and wherein the particles can be excited selectively by microwaves taking into account a material of the component to be coated, and wherein the excitation frequency for the generated microwaves is selected such that the particles present in the coating material are excited energetically but the constituents of the component, on which the layer is to be produced, are excited to a lesser degree or not at all.

According to a further embodiment, the particles may consist of boron oxide and the excitation frequency of the microwaves for boron oxide with the empirical formula BO is 53165 MHz and/or for boron oxide with the empirical formula BO₂ is 2570 GHz. According to a further embodiment, the particles may consist of titanium nitride and the excitation frequency of the microwaves is 18589 MHz. According to a further embodiment, the particles may consist of at least one of boron oxide and boron carbide and the excitation frequency of the microwaves for boron oxide with the empirical formula BO is 53165 MHz and/or for boron oxide with the empirical formula BO₂ is 2570 GHz and/or for boron carbide is 1.701 GHz. According to a further embodiment, the particles may consist of intermetallic compounds. According to a further embodiment, the intermetallic compounds can be at least one of silver chromium, gold chromium, and chromium copper wherein the excitation frequency of the microwaves for silver chromium is 13.2 GHz and/or for gold chromium is 168 MHz and/or for chromium copper is 0.14 GHz.

### BRIEF DESCRIPTION OF THE DRAWINGS

Further details of the invention are described below with reference to the drawing.

The single FIGURE shows an exemplary embodiment of the process, in which a component to be coated is introduced into a microwave oven.

### DETAILED DESCRIPTION

According to various embodiments, the excitation frequency for the generated microwaves is selected such that characteristic groups of atoms present in the coating material are preferentially excited but the constituents of the component, on which the layer is to be produced, are excited to a lesser degree or not at all. In other words, a suitable excitation frequency is set for the microwave generator so that the greatest possible heating can be produced locally in the coating material together with the lowest possible energy consumption. Firstly, in this case energy may be saved during coating, and the process is therefore advantageously more economic. In addition, it is also possible to coat comparatively thermally sensitive components, i.e. those made of plastic, since it is possible to keep the thermal loading of the component to be coated to a minimum compared to the thermal loading in the coating material.

According to a further embodiment, the coating material contains acetic acid and the excitation frequency of the microwaves is 5 GHz, or that the coating material contains propionic acid and the excitation frequency of the microwaves is 2.5 GHz. These acids have the advantage of being substances which are readily available commercially and can advantageously be procured at low cost. In addition, the use of these acids advantageously makes it possible to precisely set the viscosity of the coating material, and therefore this viscosity can be adapted to the selected process for applying the layers. The layers can be applied to the component to be coated by spraying, doctoring, immersion or else rubbing.

According to various embodiments, particles, in particular nanoparticles, are introduced into the coating material and, taking into account the material of the component to be coated, are excited selectively by the microwaves to be generated. Within the context of the present application, nanoparticles should be understood to mean particles having a mean particle diameter in the nanometer range, preferably having a mean particle diameter of at most 100 nanometers. The selection of particles which are excited selectively by the generated microwaves has the advantage that it is also possible to select materials for the composition of the coating material which cannot be heated independently of the material of the substrate component. Here, the coating material is heated indirectly via the particles introduced into the coating material. If the particles selected are nanoparticles, it is advantageously possible to prevent the integrity of the coating microstructure to be produced from being influenced. The mechanical properties of the layer to be produced are thereby largely retained.

It can be also advantageous to select nanoparticles or particles which can perform further functions in the layer to be formed. Mention should be made here of particles made from a colorant or particles which improve the anti-corrosion properties of the layer.

The materials listed in the table below are preferably suitable as the possible materials which can be selected for the particles.

| | Excitation | |
|---|---|---|
| Material | frequency | |
| Titanium nitride | 18589 | MHz |
| Boron oxide | | |
| BO₂ | 2570 | GHz |
| BO | 53165 | MHz |
| Boron carbide | 1.701 | GHz |
| Silver chromium | 13.2 | GHz |
| Gold chromium | 168 | MHz |
| Chromium copper | 0.14 | GHz |

The single FIGURE shows a microwave oven with a housing 11 which houses a microwave generator 12. A component 15 coated with a coating material 14 can be inserted through an opening 13 in the housing 11. The coating material 14 contains particles 16 which consist, for example, of titanium nitride.

The tunable microwave generator generates microwaves 17 having a frequency which excites the groups of atoms located in the particles 16. This heats up the particles which give off the heat to the coating material 14 which surrounds them. This partially heats the coating material 14 and, as a result, the ceramic layer is formed (not shown in more detail) from the ceramic precursors in the coating material. The selectivity of the excitation frequency of the microwaves means that the component 15 is heated only indirectly via the conduction of heat, which results in heat exchange between the coating material 14 and the component 15. By way of example, the component 15 may be a turbine blade or vane or a compressor blade for installation in a gas turbine.

What is claimed is:

1-8. (canceled)

9. A process for producing a ceramic layer on a component, comprising the steps of:
applying a coating material comprising a solvent and dissolved precursors of a ceramic to the component, and
subjecting the component provided with the coating material to heat treatment in which the solvent evaporates and the ceramic precursors are converted into the ceramic layer, the energy source used for the heat treatment being a microwave generator,
wherein particles are introduced into the coating material, wherein the particles are selected in view of groups of atoms which are present in the coating material, and wherein the particles can be excited selectively by microwaves taking into account a material of the component to be coated, and
wherein the excitation frequency for the generated microwaves is selected such that the particles present in the coating material are excited energetically but the constituents of the component, on which the layer is to be produced, are excited to a lesser degree or not at all.

10. The process according to claim 9, wherein the particles are nanoparticles.

11. The process according to claim 9,
wherein the particles consist of boron oxide and the excitation frequency of the microwaves for boron oxide with the empirical formula BO is 53165 MHz and/or for boron oxide with the empirical formula BO₂ is 2570 GHz.

12. The process according to claim 9,
wherein the particles consist of titanium nitride and the excitation frequency of the microwaves is 18589 MHz.

13. The process according to claim 9,
wherein the particles consist of at least one of boron oxide and boron carbide and the excitation frequency of the microwaves for boron oxide with the empirical formula BO is 53165 MHz and/or for boron oxide with the empirical formula BO₂ is 2570 GHz and/or for boron carbide is 1.701 GHz.

14. The process according to claim 9,
wherein the particles consist of intermetallic compounds.

15. The process according to claim 9,
wherein the intermetallic compounds are at least one of silver chromium, gold chromium, and chromium copper wherein the excitation frequency of the microwaves for silver chromium is 13.2 GHz and/or for gold chromium is 168 MHz and/or for chromium copper is 0.14 GHz.

16. A process for producing a ceramic layer on a component, comprising the steps of:
providing a coating material comprising a solvent, dissolved precursors of a ceramic and particles which can be excited selectively by microwaves taking into account a material of the component to be coated,
applying the coating material to the component, and
subjecting the component provided with the coating material to heat treatment by microwaves in which the solvent evaporates and the ceramic precursors are converted into the ceramic layer, wherein an excitation frequency for the microwaves is selected such that the particles present in the coating material are excited energetically but the constituents of the component, on which the layer is to be produced, are excited to a lesser degree or not at all.

17. The process according to claim 16, wherein the particles are nanoparticles.

18. The process according to claim 16,
wherein the particles consist of boron oxide and the excitation frequency of the microwaves for boron oxide with the empirical formula BO is 53165 MHz and/or for boron oxide with the empirical formula BO₂ is 2570 GHz.

19. The process according to claim 16,
wherein the particles consist of titanium nitride and the excitation frequency of the microwaves is 18589 MHz.

20. The process according to claim 16,
wherein the particles consist of at least one of boron oxide and boron carbide and the excitation frequency of the microwaves for boron oxide with the empirical formula BO is 53165 MHz and/or for boron oxide with the empirical formula BO₂ is 2570 GHz and/or for boron carbide is 1.701 GHz.

21. The process according to claim 16,
wherein the particles consist of intermetallic compounds.

22. The process according to claim 16,
wherein the intermetallic compounds are at least one of silver chromium, gold chromium, and chromium copper wherein the excitation frequency of the microwaves for silver chromium is 13.2 GHz and/or for gold chromium is 168 MHz and/or for chromium copper is 0.14 GHz.

23. A system for producing a ceramic layer on a component, comprising:
a coating material comprising a solvent, dissolved precursors of a ceramic and particles or nanoparticles which can be excited selectively by microwaves taking into account a material of the component to be coated,
a component to which the coating material is applied, and
a microwave generator for subjecting the component provided with the coating material to a heat treatment by microwaves in which the solvent evaporates and the ceramic precursors are converted into the ceramic layer, wherein an excitation frequency for the microwaves is selected such that the particles present in the coating material are excited energetically but the constituents of the component, on which the layer is to be produced, are excited to a lesser degree or not at all.

24. The system according to claim 23,
wherein the particles consist of boron oxide and the excitation frequency of the microwaves for boron oxide with the empirical formula BO is 53165 MHz and/or for boron oxide with the empirical formula BO₂ is 2570 GHz.

25. The system according to claim 23,
wherein the particles consist of titanium nitride and the excitation frequency of the microwaves is 18589 MHz.

26. The process according to claim 23,
wherein the particles consist of at least one of boron oxide and boron carbide and the excitation frequency of the microwaves for boron oxide with the empirical formula BO is 53165 MHz and/or for boron oxide with the empirical formula BO₂ is 2570 GHz and/or for boron carbide is 1.701 GHz.

27. The system according to claim 23,
wherein the particles consist of intermetallic compounds.

28. The process according to claim 23,
wherein the intermetallic compounds are at least one of silver chromium, gold chromium, and chromium copper wherein the excitation frequency of the microwaves for silver chromium is 13.2 GHz and/or for gold chromium is 168 MHz and/or for chromium copper is 0.14 GHz.
